(19) United States
(12) Patent Application Publication
(10) Pub. No.: US 2026/0196050 A1
(43) Pub. Date: Jul. 9, 2026

(54) CONTAMINATION INDICATOR FOR REFUSE COLLECTION SYSTEM

(71) Applicant: Oshkosh Corporation, Oshkosh, WI (US)

(72) Inventors: John Boncyzk, Oshkosh, WI (US); Brian Brost, Oshkosh, WI (US); Bryan Fenster, Oshkosh, WI (US); Jerrod Kappers, Oshkosh, WI (US); Lee Drees, Oshkosh, WI (US)

(73) Assignee: Oshkosh Corporation, Oshkosh, WI (US)

(21) Appl. No.: 19/439,165

(22) Filed: Jan. 2, 2026

Related U.S. Application Data
(60) Provisional application No. 63/741,576, filed on Jan. 3, 2025.

(51) Int. Cl. G06V 20/52; B60Q 9/00; B65F 3/02; G06T 7/00; G06T 7/62; G06V 20/56

(52) U.S. Cl. CPC G06V 20/52; B60Q 9/00; B65F 3/02; G06T 7/0002; G06T 7/62; G06V 20/56; B65F 2003/0216; G06T 2207/30252

(57) ABSTRACT

A refuse vehicle includes: a chassis supporting a plurality of tractive elements; a body assembly coupled to the chassis, the body assembly defining a refuse compartment; a sensor coupled to the body assembly and configured to generate scan data of refuse material associated with the refuse compartment; a contamination level indicator including a scale indicator; and a controller communicably coupled to the sensor and the contamination level indicator. The controller is configured to: receive the scan data from the sensor; determine a level of contamination of an object within the refuse material based on the scan data; and transmit a signal indicative of the level of contamination to the contamination level indicator to cause the scale indicator to present the level of contamination.

### CROSS REFERENCE TO RELATED APPLICATIONS

This application claims the benefit of and priority to U.S. Provisional Patent Application No. 63/741,576, filed Jan. 3, 2025, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

At least one exemplary embodiment relates to a refuse vehicle including: a chassis supporting a plurality of tractive elements; a body assembly coupled to the chassis, the body assembly defining a refuse compartment; a sensor coupled to the body assembly and configured to generate scan data of refuse material associated with the refuse compartment; a contamination level indicator including a scale indicator; and a controller communicably coupled to the sensor and the contamination level indicator. The controller is configured to: receive the scan data from the sensor; determine a level of contamination of an object within the refuse material based on the scan data; and transmit a signal indicative of the level of contamination to the contamination level indicator to cause the scale indicator to present the level of contamination.

Another exemplary embodiment relates to a contamination level detection system for a refuse vehicle. The contamination level detection system includes: a sensor configured to generate scan data of refuse material within a refuse compartment of the refuse vehicle; a contamination level indicator including a scale indicator; and a controller communicably coupled to the sensor and the contamination level indicator. The controller is configured to: receive the scan data from the sensor; determine a level of contamination of an object within the refuse material based on the scan data; and cause the contamination level indicator to present an indication of the level of contamination on the scale indicator.

Another exemplary embodiment relates to a method of determining and displaying a level of contamination of refuse material in a refuse vehicle on a contamination level indicator disposed within the refuse vehicle, and in which the contamination level indicator includes a scale indicator. The method includes: receiving scan data from a sensor of refuse material associated with a refuse compartment; determining a level of contamination of an object within the refuse material based on the scan data; and transmitting a signal indicative of the level of contamination to a contamination level indicator to cause the scale indicator to present the level of contamination.

Another exemplary embodiment relates a refuse vehicle including a body assembly, a sensor, and one or more processing circuits. The body assembly defines a refuse compartment. The sensor is coupled to body assembly and is configured to generate scan data of refuse material within the refuse compartment. The one or more processing circuits are configured to obtain the scan data from the sensor; determine a level of contamination of the refuse material based on the scan data; and transmit a signal indicative of the level of contamination.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment;

FIG. 2 is a block diagram of a control system of a refuse vehicle that includes a contamination level determination system, according to an exemplary embodiment;

FIG. 3 is a perspective view of a rear loading refuse vehicle equipped with a contamination level determination system in a hopper region of the refuse vehicle, according to an exemplary embodiment;

FIG. 4 is a perspective cross-sectional view of a side loading refuse vehicle equipped with a contamination level determination system positioned in a hopper region of the refuse vehicle, according to an exemplary embodiment;

FIG. 5 is an illustration of a display of a contamination level determination system showing identification of objects within the refuse material, according to an exemplary embodiment;

FIG. 6A is a perspective view of a user interface display of a contamination level determination system showing identification of objects within the refuse material, according to another exemplary embodiment;

FIG. 6B is a perspective view of the display of the contamination level determination system of FIG. 6A after emptying a refuse container into the hopper;

FIG. 7 is a front perspective view of a monitor including a contamination indicator for a contamination level determination system, according to an exemplary embodiment;

FIG. 8 is a front view of a joystick including a contamination indicator for a contamination level determination system, according to an exemplary embodiment;

FIG. 9 is a front view of a steering wheel including a contamination indicator for a contamination level determination system, according to an exemplary embodiment;

FIG. 10 is a front view of an A-pillar region of a refuse vehicle including a contamination indicator for a contamination level determination system, according to an exemplary embodiment;

FIG. 11 is a front view of multiple different types of contamination indicators, according to various exemplary embodiments; and

FIG. 12 is a flow diagram of a method for determining a contamination level of refuse material for a refuse vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Embodiments of the present disclosure generally relate to a refuse vehicle that includes a contamination system for detecting levels of contaminants (e.g., non-refuse objects, non-recyclable objects, etc.) within refuse materials received by a refuse vehicle, and a simplified indicator for presenting contamination levels to a vehicle operator. In some embodiments, the contamination system includes a sensor that is configured to generate scan data (e.g., images, etc.) of refuse materials received by the vehicle, such as in a hopper volume of the refuse vehicle, a storage volume, or in any other location along the vehicle. The contamination system is configured to analyze the sensor data to identify contaminants and to quantify the amount of contaminants within the waste stream.

The contamination system may also be configured to display contamination levels for operator and/or third-party review in a convenient user interface format (e.g., display format) that can facilitate rapid identification of high levels of contaminants in the refuse stream. For example, the contamination system may include a simplified user display interface including a scale indicator or similar indicator (e.g., such as multiple light emitting diodes arranged in a row or column) to indicate contamination levels (e.g., relative levels of contamination). Such a format can significantly improve operator cognition of relative levels of contamination along the route (or on a per stop basis). The indicator may also be configured to generate alerts depending on the type of contamination detected. In some embodiments, the indicator is disposed along an operator's field of view when driving the vehicle (e.g., when performing transit operations), which can significantly improve operator safety and productivity by eliminating the need to interact with separate interfaces to determine contamination levels while on route.

### Overall Vehicle

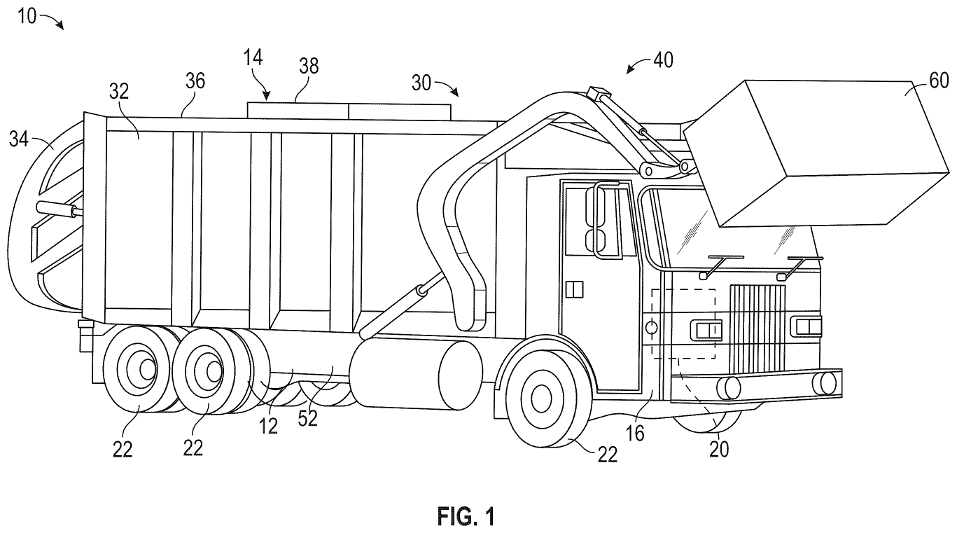

Referring to FIG. 1, a vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 provides power to a plurality of tractive elements and/or motive members, shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 20 may be configured to use a variety of fuels (e.g., gasoline, diesel, biodiesel, ethanol, natural gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and, in particular, the on-board refuse container, defines a refuse compartment 30. In some embodiments, the body 14 includes a plurality of panels, shown as panels 32, a tailgate 34, and a cover 36 that together define the refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle at rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30, such as during transit operations (e.g., due to wind, bumps in the road, etc.).

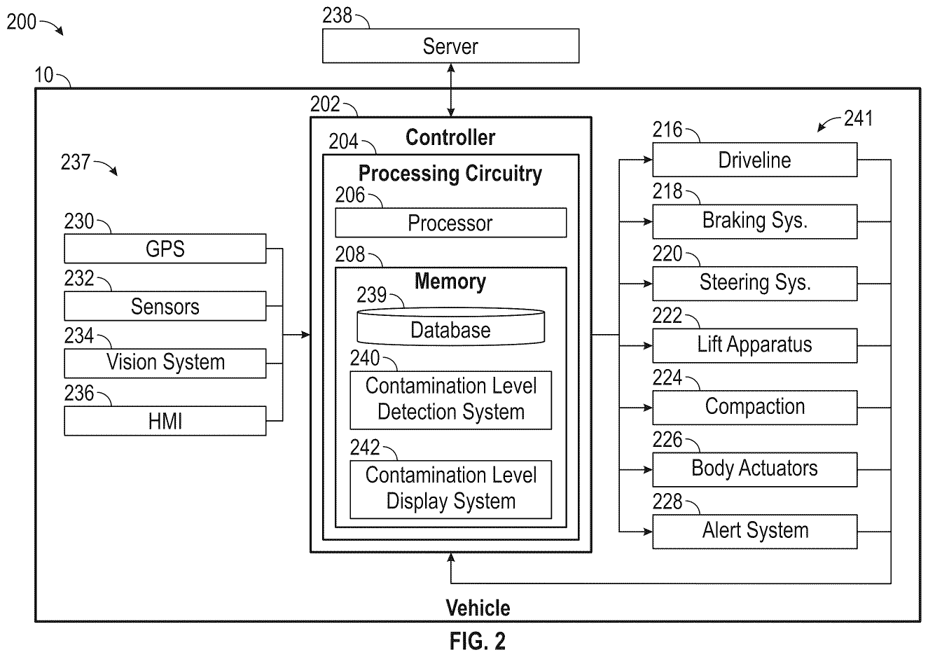

Referring to FIG. 2, the refuse vehicle 10 may include a control system 200 that is configured to facilitate operation of the refuse vehicle 10, or components thereof. In some embodiments, the control system 200 is configured to facilitate autonomous or semi-autonomous operation of the refuse vehicle 10, or components thereof. The control system 200 includes a controller 202 that is positioned on the refuse vehicle 10, a server 238, one or more input devices 237, and one or more controllable elements 241. The input devices 237 can include a Global Positioning System (“GPS”), multiple sensors 232, a vision system 234 (e.g., an awareness system), and a Human-Machine Interface (“HMI”) 236. The controllable elements 241 can include a driveline 216 of the refuse vehicle 10, a braking system 218 of the refuse vehicle 10, a steering system 220 of the refuse vehicle 10, a lift apparatus 222 (e.g., the lift assembly 40), a compaction system 224 (e.g., a packer assembly, a packer, etc.), body actuators 226 (e.g., tailgate actuators, lift or dumping actuators, etc.), and/or an alert system 228.

The controller 202 (which may include one or more controllers) includes processing circuitry 204 including a processor 206 (which may include one or more processors, according to various exemplary embodiments) and memory 208. Processing circuitry 204 can be communicably connected with a communications interface of controller 202 such that processing circuitry 204 and the various components thereof can send and receive data via the communications interface. Processor 206 can be implemented as a general-purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to some embodiments, memory 208 is communicably connected to processor 206 via processing circuitry 204 and includes computer code for executing (e.g., by at least one of processing circuitry 204 or processor 206) one or more processes described herein.

The controller 202 is configured to receive inputs (e.g., measurements, detections, signals, sensor data, etc.) from the input devices 237, according to some embodiments. In particular, the controller 202 may receive a GPS location from the GPS system 230 (e.g., current latitude and longitude of the refuse vehicle 10). The controller 202 may receive sensor data (e.g., engine temperature, fuel levels, transmission control unit feedback, engine control unit feedback, speed of the refuse vehicle 10, RFID signals, etc.) from the sensors 232. The controller 202 may receive image data (e.g., real-time camera data) from the vision system 234 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, within the compactor of the refuse vehicle 10, etc.). The controller 202 may receive user inputs from the HMI 236 (e.g., button presses, requests to start or stop a lifting or loading operation, driving operations, steering operations, braking operations, safety override, alert clearance, etc.).

The controller 202 may be configured to provide control outputs (e.g., control decisions, control signals, etc.) to the driveline 216 (e.g., the engine, the transmission, the engine control unit, the transmission control unit, etc.) to operate the driveline 216 to transport the refuse vehicle 10. The controller 202 may also be configured to provide control outputs to the braking system 218 to activate and operate the braking system 218 to decelerate the refuse vehicle 10 (e.g., by activating a friction brake system, a regenerative braking system, etc.). The controller 202 may be configured to provide control outputs to the steering system 220 to operate the steering system 220 to rotate or turn at least two of the wheels 22 to steer the refuse vehicle 10. The controller 202 may also be configured to operate actuators or motors of the lift apparatus 222 (e.g., lift assembly 40) to perform a lifting operation (e.g., to grasp, lift, empty, and return a refuse container). The controller 202 may also be configured to operate the compaction system 224 to compact or pack refuse that is within the refuse compartment 30. The controller 202 may also be configured to operate the body actuators 226 to implement a dumping operation of refuse from the refuse compartment 30 (e.g., driving the refuse compartment 30 to rotate to dump refuse at a landfill). The controller 202 may also be configured to operate the alert system 228 (e.g., lights, speakers, display screens, etc.) to provide one or more aural or visual alerts to nearby individuals.

The controller 202 may also be configured to receive feedback from any of the driveline 216, the braking system 218, the steering system 220, the lift apparatus 222, the compaction system 224, the body actuators 226, or the alert system 228. The controller may provide any of the feedback to the server 238 via a communications interface (not shown). The communications interface may include any wireless transceiver, cellular dongle, communications radios, antennas, etc., to establish wireless communication with the server 238. The communications interface may facilitate communications with nearby refuse vehicles 10 to thereby establish a mesh network of refuse vehicles 10.

The controller 202 is configured to use any of the inputs from any of the GPS system 230, the sensors 232, the vision system 234, or the HMI 236 to generate controls for any one, or any combination of, the driveline 216, the braking system 218, the steering system 220, the lift apparatus 222, the compaction system 224, the body actuators 226, or the alert system 228. In some embodiments, the controller 202 is configured to operate the driveline 216, the braking system 218, the steering system 220, the lift apparatus 222, the compaction system 224, the body actuators 226, and/or the alert system 228 to autonomously transport the refuse vehicle 10 along a route (e.g., self-driving), perform pickups or refuse collection operations autonomously, and transport to a landfill to empty contents of the refuse compartment 30. The controller 202 may receive one or more inputs from the server 238 such as route data, indications of pickup locations along the route, route updates, customer information, pickup types, etc. The controller 202 may use the inputs from the server 238 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the server 238 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The server 238 may perform any of the route planning techniques as described in greater detail in U.S. application Ser. No. 18/111,137, filed Feb. 17, 2023, the entire disclosure of which is incorporated by reference herein. The server 238 may implement any route planning techniques based on data received by the controller 202. In some embodiments, the controller 202 is configured to implement any of the cart alignment techniques as described in U.S. application Ser. No. 18/242,224, filed Sep. 5, 2023, the entire disclosure of which is incorporated by reference herein. The refuse vehicle 10 and the server 238 may also operate or implement geofences as described in greater detail in U.S. application Ser. No. 17/232,855, filed Apr. 16, 2021, the entire disclosure of which is incorporated by reference herein.

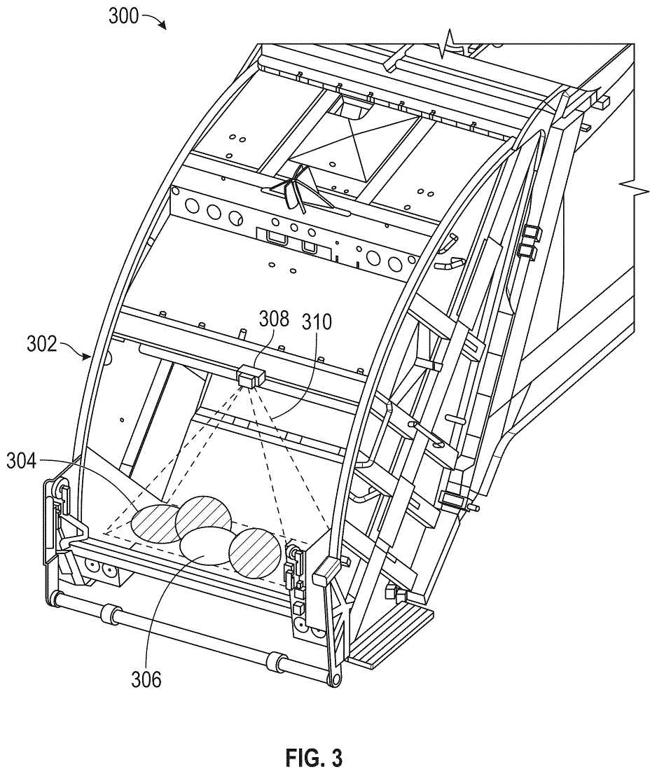

Still referring to FIG. 2, the memory 208 of the controller 202 includes a database 239, a contamination level detection system 240, and a contamination level reporting system shown as contamination level display system 242. The contamination level detection system 240 may obtain scan data from the vision system 234 (e.g., from sensors thereof), such as images of the hopper that are within a perception area cameras that are coupled to the body or to other areas of the refuse vehicle (e.g., a perception area 310 of FIG. 3). As used herein, “perception area” may refer to an area that is viewable by the cameras (e.g., a field of view of the cameras, etc.). For example, as shown in FIG. 3, for a camera oriented toward a hopper volume of the refuse vehicle, the perception area may include a region of the hopper volume that receives refuse from a refuse container.

The contamination level detection system 240 implemented by the processing circuitry 204 of the controller 202 is configured to determine an amount of certain objects or types of objects (e.g., contaminants such as non-intended waste products and/or streams) within the refuse material, such as relative to a total volume of the refuse material contained within the hopper volume (e.g., a volume fraction) and/or relative to a total mass of the refuse material contained within the hopper volume (e.g., a mass fraction). In other embodiments, and depending on the location of the vision system 234, the contamination level detection system 240 may be configured to determine a volume fraction and/or a mass fraction of certain objects or types of objects within the storage volume or in other locations along the refuse vehicle. In still further embodiments, the contamination level detection system 240 is configured to determine a fraction of certain objects or types of objects within the perception area of one or more sensors 232, or in an effective outward facing area of the hopper volume.

In some embodiments, the contamination level detection system 240 is configured to identify non-refuse objects (e.g., contaminants) in the refuse material that are not permitted to be discarded (e.g., that are different from the types of refuse materials intended for receipt and disposal by the refuse vehicle). Examples of non-refuse objects may include aerosol cans, liquids, animals, antifreeze, appliances, asbestos, barrels, batteries, chemical products, computers, contaminated oils (mixed with solvents, gasoline, etc.), dirt/soil, fluorescent tubes, hazardous waste, herbicides and pesticides, persons, industrial waste, lead-based painted debris, lubricating/hydraulic oil, medical waste, microwaves, mattresses, monitors, motor oil, oil filters, other flammable liquids, paint (except dried latex paint cans, no liquids), PCB/PCB-containing material, propane tanks, radioactive material, railroad ties, solvents, televisions, tires, transmission oil, concrete, bricks, and/or demolition material. In some embodiments, such as in a recycling refuse vehicle intended to receive recycling materials, the contaminants may include non-recyclable materials. In some embodiments, such as in refuse vehicles intended to receive organic waste, the contaminants may include recyclable materials that should be disposed of in a separate waste stream.

In some embodiments, the contamination level detection system 240 is also configured to identify refuse objects in the refuse material. Refuse objects may, in some embodiments, be all other objects not determined to be non-refuse (e.g., all non-contaminants).

The contamination level detection system 240 may be configured to implement any machine learning, neural network, or artificial intelligence in order to identify various types of objects (e.g., types of refuse and non-refuse) within the hopper volume and/or the storage volume. For example, the controller 202 may implement object detection by performing any of the functionality described in U.S. application Ser. No. 16/758,834, filed Apr. 23, 2020, the entire disclosure of which is incorporated by reference herein. Such operations may be implemented locally on the controller 202, remotely by the server 238, or in some combination of both the controller 202 and the server 238.

The contamination level detection system 404 may be configured to determine an amount (e.g., a relative amount, a fraction relative to a total volume, mass, and/or area occupied by refuse material, as described above) of the contaminants (e.g., the amount of non-refuse objects) within the refuse material and provide the detection results to the contamination level display system 242 and/or the alert system 228.

The contamination level display system 242 is configured to receive data from the contamination level detection system and cause the HMI 236 to display an indication of the determined contamination levels. In some embodiments, the contamination level display system 242 is also configured to transmit the contamination level to the server 238 for remote monitoring and/or analysis, as will be further described.

In at least one embodiment, the contamination level display system 242 is also configured to control operation at least one component of the refuse vehicle 10 (e.g., the driveline 216, the braking system 218, the steering system 220, lift apparatus 222, the compaction system 224, and/or a hopper actuator 412) based on the contamination level from the contamination level detection system 240. For example, in response to receiving an indication from the contamination level detection system 338 that a contaminant (e.g., a non-refuse object) is present within the hopper volume of the vehicle, the contamination level display system 242 may transmit control signals to instruct the driveline 216 to stop operation, the braking system 218 to brake the vehicle 10, stop refuse collection by the lift apparatus 222, halt the compaction system 224 from compacting refuse within the refuse vehicle 10, stop the hopper actuator 412 from directing refuse into the body of the vehicle 10, and/or display a prompt on an operator interface of the refuse vehicle 10 requiring input from the operator before allowing any further operation.

In some embodiments, the contamination level display system 242, upon receiving an indication of the contaminant (e.g., the non-refuse object) within the hopper volume of the refuse vehicle 10 and transmitting control signals to the one or more controllable elements 241 and/or transmitting a signal indicative of the contamination level to the HMI 236, may require receipt of an indication overriding the detection of the contaminant. The indication may come from a user input through the HMI 236 such as by selection of a selectable element on the HMI 236 (e.g., a button, a switch, etc.). In other embodiments, the HMI 236 may be at the entrance of the hopper of the vehicle 10. Thus, requiring an operator of the refuse vehicle 10 to physically be present at the hopper to indicate removal of the contaminant or non-presence of contaminant. In other embodiments, the HMI 236 may display a video or image stream of the hopper volume (e.g., the perception area) of the refuse vehicle 10 to the operator of the vehicle within the cab of the vehicle 10.

Referring to FIG. 3, a refuse vehicle 300 that includes a contaminant level detection system is shown, according to an exemplary embodiment. The refuse vehicle 300 includes a back-loading hopper volume 302 and a sensor 308 coupled to the back-loading hopper volume 302. The sensor 308 may include an image sensor (e.g., a camera), a material sensor (e.g., a metal detector), an X-ray, a neutron scanner, or any other type of materials or object detection device. The sensor 308 may have a perception area 310 that corresponds to an area within the back-loading hopper volume 302 such that scan data captured of the perception area 310 include scan data of refuse and non-refuse objects contained within the refuse material (e.g., a refuse object 304 and a contaminant 306/non-refuse object) within the back-loading hopper volume 302. Although exemplary embodiments herein are described with reference to contamination detection in the hopper volume 302, it is noted that a similar system may be implemented for the storage volume within the body assembly of the refuse vehicle and/or in any other location.

The refuse object 304 may be any object to be discarded and/or also permitted to be discarded. Exemplary types of refuse object 304 may be trash and/or recyclable materials that are suitable for processing by a waste processing facility. The contaminant 306 (e.g., the non-refuse object) may be any object within the back-loading hopper volume 302 that is unpermitted within the hopper volume 302, as described above.

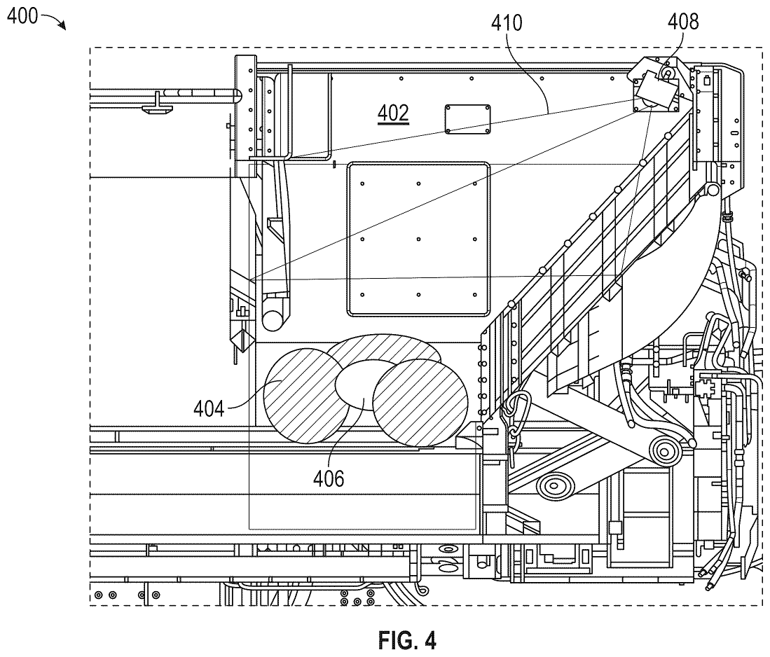

The arrangement of the sensor for the contamination level detection system may be different in various embodiments and depending on the loading configuration of the refuse vehicle. For example, and referring to FIG. 4, an alternative embodiment of a refuse vehicle 400 is shown that includes a top-loading hopper volume 402 (e.g., a hopper volume for use with a side loading refuse vehicle or a front-loading refuse vehicle). The vehicle 400 may include a sensor 408 with a perception area 410 that corresponds to an area and/or region of the hopper volume 402 at a maximum fill level of the hopper volume 402 such that the sensor 408 can generate scan data of refuse material within the refuse compartment. The scan data may include images (e.g., the of the refuse materials within the hopper volume 402, or other sensor data from other types of sensors that may be used to differentiate between different types of materials within the hopper volume 402. The scan data may be indicative of the entire contents of the hopper volume 402, or at least the contents of the hopper volume 402 along an upper layer of refuse material within the hopper volume 402.

While the perception area 410 is depicted as including an area or volume within the top-loading hopper volume 402, it should be understood that the perception area 410 may additionally or alternatively include a dump area across which all refuse material entering the hopper volume 402 passes before coming to rest within the refuse compartment. For example, the sensor 408 may include a perception area that perceives an area through which all collected objects pass when entering the hopper volume 402 after being dumped by a lift assembly (e.g., an area adjacent to the opening of the hopper volume 402, an opening into the hopper volume 402 through a top door of the refuse vehicle, etc.). In so doing, the sensor 408 may receive scan (e.g., image) data of the collected objects as they enter the hopper volume 402 as opposed to when they are already within the hopper volume 402.

Turning now to FIG. 5, the HMI may include a graphical user interface 500 with one or more interactive elements 511 (e.g., visually perceptible elements, display elements) to facilitate identification of refuse and contaminants (e.g., non-refuse objects) identified by the contamination level detection system. The graphical user interface 500 may be a transmitted view of a vehicle's hopper volume, storage volume, or other refuse receiving and/or holding area. The view may correspond with a perception area of a sensor coupled to the vehicle (e.g., the perception area 310 of FIG. 3, the perception area 410 of FIG. 4).

Within the graphical user interface 500 may be depictions (whether virtual or captured) of objects within the hopper such as object 503 and object 505. The contamination level display system (e.g., the contamination level display system 242 of FIG. 2) may be executed to display the graphical user interface 500 of FIG. 5. For example, and referring again to FIG. 2, the memory 208 of the controller 202 may include various stored modules or subsystems that, when executed by the processing circuitry 204 cause the controller 202 to perform one or more computer-implemented methods for contamination level detection and processing as disclosed herein.

For example, the memory 208 may include a display manager (not shown) that may be configured to provide display data based on information from the contamination level detection system 240. The controller 202, via the contamination level display system 242, may be configured to provide the display data overlaid onto an image or scan of the refuse material to an operator of the refuse vehicle or a user that remotely controls or monitors the refuse vehicle (e.g., via the server 238).

As shown in FIG. 5, the display data may include various callouts 504, 506, 508 overlaid or superimposed onto a real-world or digital image of the hopper volume 502. The callouts 504, 506, 508 may indicate the results of the contamination level detection system 240 of FIG. 2 and can include lines indicating the corresponding features. For example, as shown in FIG. 5, the display data may include a first callout 504 or visual indication that indicates the results of an object detection or object-type detection of an object 503. As used herein, the “object 503” may refer to a type of a contaminant such as a material or type of material within the refuse materials. The display data may also include a second callout 508 or visual indication that indicates the results of image analysis of particular features of the object 503 (e.g., an object detection, an object type, a confidence level, and/or a selectable input to override the alert). The display data may also include a third callout 506 indicating the presence of a detected object 505.

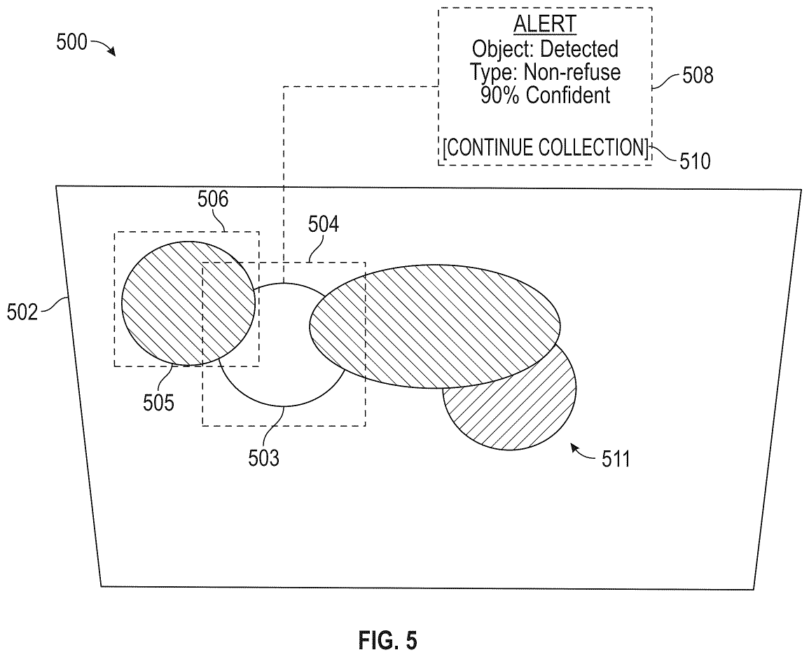

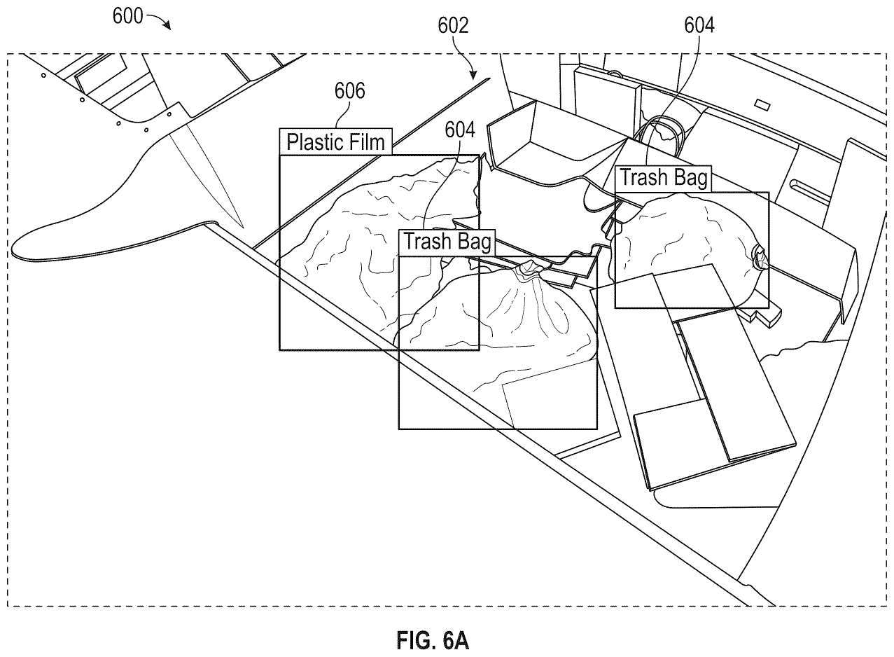

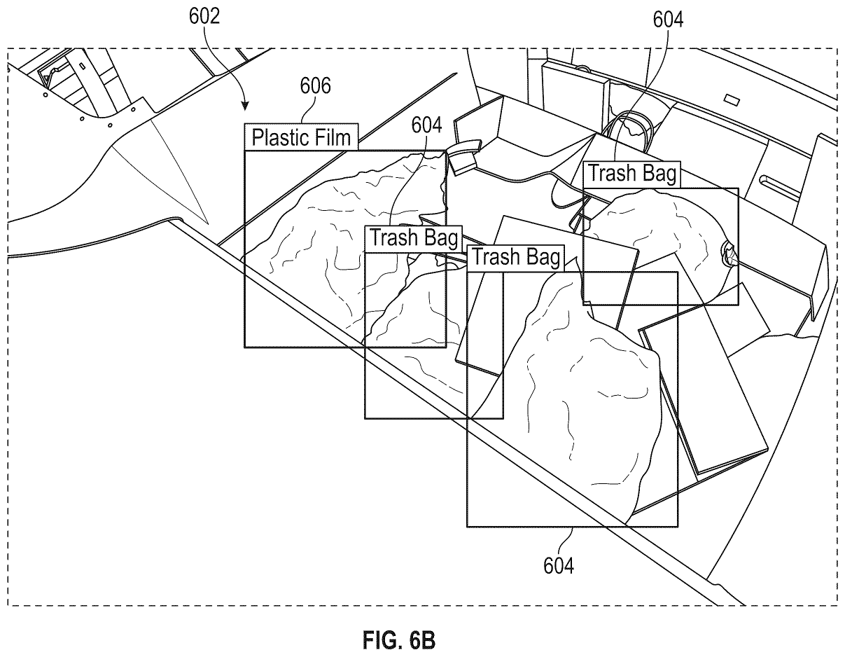

The display data may be different in various embodiments. For example, and referring to FIGS. 6A and 6B, different views of a perception area 600 of a hopper volume 602 are shown before and after loading additional refuse materials into the hopper volume 602. The display data includes call outs for any non-recyclable materials that have been added to the hopper volume 602. In the embodiment of FIG. 6A, the display data includes a first call out 604 or visual indication of the presence of a first object (e.g., a trash bag) within the hopper volume 602, and a second call out 606 or visual indication of the presence of a second object (e.g., a plastic film) within the hopper volume 602. As shown in FIG. 6B, the system may be configured to overlay the first call out 604 or the second call out 606 in real time onto a video or most recent image from the camera (for example, as refuse material is being added/deposited into the hopper volume 602 as shown in FIG. 6B).

Upon identifying the objects (e.g., non-refuse objects, contaminants, etc.), the contamination level detection system 240 (see FIG. 2) may be configured to determine an amount of contamination (e.g., a contamination level) within the refuse material and transmit the contamination level to the contamination level display system 242 for reporting to an operator or fleet management service.

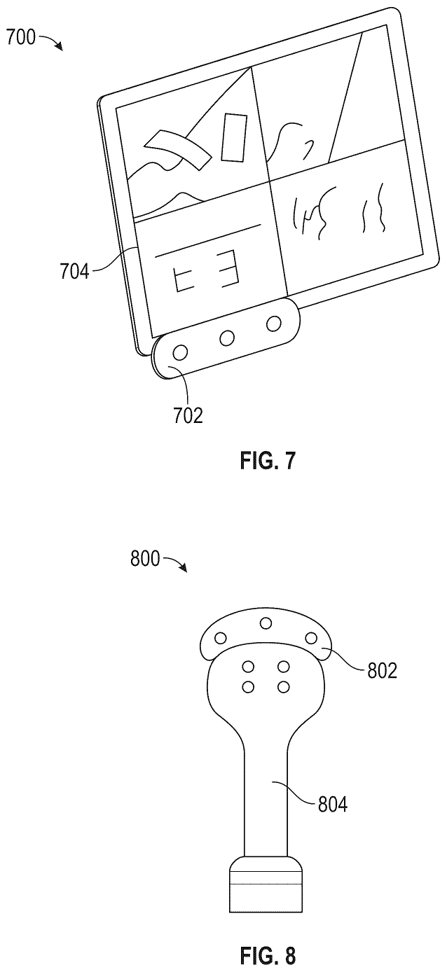

Referring to FIGS. 7-10, various exemplary embodiments of a contamination level indicator are shown for presenting contamination levels to an operator of the refuse vehicle. In the embodiment of FIG. 7, the contamination level indicator 700 includes a scale 702 (e.g., a scale indicator, a percentage indicator, a graduated scale, a level gauge and/or indicator, a meter, etc.) having a plurality of light elements (e.g., light emitting diodes, etc.) that are configured to indicate contamination levels within the refuse material. For example, the scale 702 may be configured to visually indicate a percentage level (e.g., on a mass, area, and/or volume basis) of contamination within the refuse material by illuminating a portion of the scale (e.g., a subset of the plurality of light elements) corresponding with the percentage level of contamination, such that a fraction of the illuminated light elements along the scale approximately corresponds with a relative fraction of contamination within the refuse material (e.g., illuminating 50% of the light elements along a portion of the scale from the left hand side of the scale corresponds with contamination levels of approximately 50% of the total refuse material within the hopper or storage volumes). In some embodiments, the controller (e.g., the controller 202 of FIG. 2) may be configured to determine a weighted level of contamination (e.g., using a multiplier and/or one or more weighting factors as described herein) and to present a weighted scale of the contamination (e.g., a mass fraction or volume fraction normalized by a threshold contamination fraction). For example, the controller may be configured to present a scale value of a threshold value of contamination in the refuse material (e.g., where the threshold value is a 5% volume fraction of contamination, and there is 2.5% measured volume fraction, the scale value may indicate 50%, etc.). Such an arrangement can improve operator recognition of unacceptable contamination levels and simplify the overall display format.

In some embodiments, the contamination level reporting system (e.g., the contamination level indicator 700) is configured to report a 100% contamination level or another high level of contamination based on a determination that the dangerous contaminate/object is present within the refuse material (e.g., an explosive device, a hazardous component or material, etc.). For example, and referring to FIG. 2, the controller 202 may be configured to apply a multiplier (e.g., a weighting factor) to the weight, area, and/or volume fraction of contamination based on the type of contamination that is detected. In some embodiments, the multiplier depends on the type of contamination (e.g., batteries or other hazardous waste having a greater multiplier as compared to non-recyclable materials such as organic waste).

In some embodiments, the contamination indicator is configured to display different color light elements and/or patterns of illumination across the scale to identify different conditions, contamination levels, and/or contaminant types to the operator.

The scale 702 is disposed within the operator's (e.g., the driver's) field of view within the cab of the vehicle. In the embodiment of FIG. 7, the scale 702 is coupled to a monitor 704 of the refuse vehicle. The monitor 704 may be part of the HMI (e.g., the HMI 236) disposed within the cab of the refuse vehicle. The scale 702 is disposed along an edge (e.g., a lower edge) of the monitor 704 and extends across a portion of the edge. In some embodiments, the scale 702 is integrated into the user interface of the monitor (e.g., as a software interface), and is shown as a visually perceptible indicator in the user interface alongside other controls/display elements.

In the embodiment of FIG. 8, the contamination indicator 800 includes a scale 802 coupled to or integrally formed with a working component control interface of the refuse vehicle (e.g., an HMI configured to control operation of one or more working components of the refuse vehicle that move relative to the refuse vehicle, such as a lift assembly). For example, and as shown in FIG. 8, the contamination indicator 800 includes a scale 802 coupled to or integrally formed with a joystick 804 that is used to control various refuse collection operations (e.g., movement/actuation of the grabber arm, etc.). In some embodiments, and as shown, the scale 802 is coupled to an outer end of the joystick 804 and extends across an upper surface of the joystick 804 adjacent to other control buttons of the joystick 804.

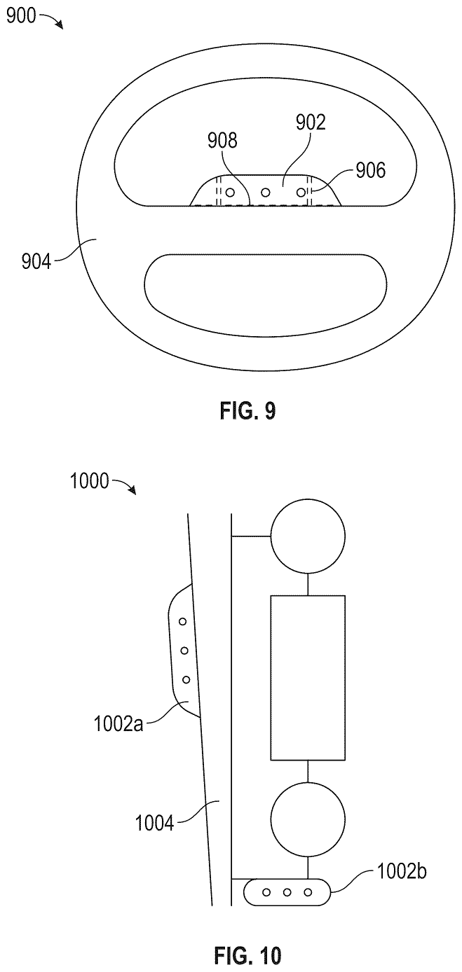

In some embodiments, the contamination indicator may be coupled to an interface of the drivetrain for the vehicle (e.g., to the interface of a third-party manufactured chassis used to control non-working components of the refuse vehicle that are separate from the working components used for refuse collection operations). For example, as shown in FIG. 9, the contamination indicator 900 includes a scale 902 coupled to the steering wheel 904 within the cab of the vehicle. The scale 902 extends across an upper surface of a central portion of the steering wheel 904, and is disposed within a gap between the central portion and an outer ring of the steering wheel 904. In some such embodiments, the contamination indicator may be formed separately from the interface (e.g., the steering wheel) and may be connected to any components within or exterior to the cab of the refuse vehicle, based on user preferences. For example, the scale 902 may include mounting openings 906 for mechanical fasteners, an adhesive product 908, or another type of mount to support the scale 902 on another component.

In the embodiment of FIG. 10, the contamination indicator 1000 includes a scale 1002a that is coupled to and extends along an A-pillar 1004 of the cab of the vehicle. In other embodiments, the scale 1002a may be positioned along another portion of the vehicle that is within the operator's field of view during transit operations (e.g., that is positioned in line with a field of view of the operator when driving the refuse vehicle). For example, the contamination indicator 1000 may include a scale 1002b that is coupled to a support structure for a rearview mirror or to the mirror itself so that a user can view the scale 1002b during transit operations, and without diverting their eyes from the road or mirrors.

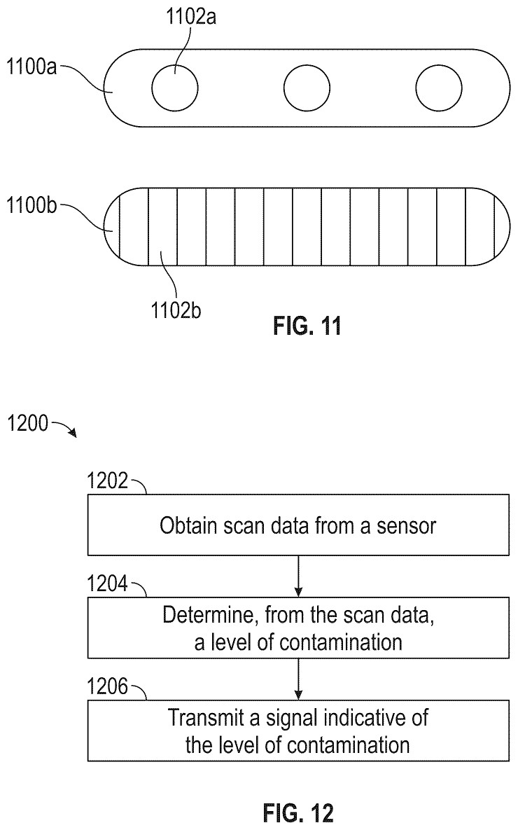

It should be appreciated that the position and arrangement of the contamination indicator may be different in various embodiments. The arrangement and number of light elements along the indicator may also be different in various embodiments. For example, referring to FIG. 11, the contamination indicator 1100a may include multiple light elements 1102a (e.g., individual LEDs) spaced apart from one another along the length of the contamination indicator 1100a, and/or a light strip having independently controllable light elements or portions along a length thereof. In other embodiments, the contamination indicator 1100b may include a continuous scale formed by light elements or lighted portions 1102b that are in contact with one another along the length of the scale. In some embodiments, the controller (e.g., the controller 202 of FIG. 2) is configured to transmit a control signal to illuminate a number or fraction of light elements/portions that correspond with an amount of contamination in the refuse material.

In some embodiments, an existing display or monitor within the cab may be configured to indicate the contamination levels (e.g., to present the scale) instead of, or in addition to, a separate contamination indicator. In such embodiments, the contamination indicator may be formed as a digital representation on the screen of the display and may form part of the graphical user interface of the display. The display may be configured as an interactive (e.g., touchscreen) display and may be configured to present more information (e.g., data fields, camera views of the hopper volume, etc.) responsive to user inputs (e.g., responsive to a user selecting the contamination indicator, etc.). For example, responsive to selection of the scale, the user interface of the display may present a primary type of contamination (e.g., a primary type of material that comprises the contamination), the amount and/or proportion of different types of contaminants in the refuse material (e.g., 10% recyclables, 2% batteries, 88% organic material),

In some embodiments, the contamination level reporting system (e.g., the contamination level display system 242 of FIG. 2) is also configured to control operation of one or more functions of the refuse vehicle 10 based on contamination levels. For example, the system may be configured to cease operation of a hopper actuator to prevent directing refuse from the hopper into the body of the refuse vehicle 10, ceasing movement of the refuse vehicle 10, ceasing compaction of refuse within the refuse vehicle 10, ceasing collection of a cart, presenting audible alerts and/or tactile alerts.

In some embodiments, upon determining the presence of the object within the hopper volume and/or displaying the alert in various callouts, the contamination level detection system may require receipt of an alert override, such as an indication of a selection of the one or more interactive elements of the HMI (e.g., the scale, etc.). The graphical user interface (e.g., as depicted in FIG. 5) may present a live or substantially live stream of the contents of the hopper volume on a display device to the user within the cab of the refuse vehicle, facilitating a manual review of the contents of the hopper volume to determine if the object(s) is, indeed, non-refuse and/or needs to be removed from the refuse material. In some embodiments, the user is able to make a selection to override the alert from within the cab. In some embodiments, the overriding selection may come from a user interface positioned on an exterior of the vehicle, thus facilitating a visual inspection of the hopper volume. In some embodiments, a user's input to operate the vehicle provides the overriding indication (e.g., pressing on a brake or acceleration pedal). In some embodiments, the refuse vehicle is operated and/or supervised remotely. In such embodiments, the overriding indication may come from a remote server communicably coupled to the refuse vehicle. Upon receiving an overriding indication from a user input, the vehicle may resume operation, either manually or automatically.

In some embodiments, the contamination level detection system may be configured to facilitate redirecting the refuse vehicle to a different transfer station or location based on the contamination level within the refuse material. For example, the contamination level reporting system may be configured to present instructions to the operator to redirect the vehicle to a different transfer station or location responsive to a determination that the contamination level exceeds a contamination level threshold. In other embodiments, the contamination level reporting system may be configured to receive instructions from a fleet management service (e.g., a third-party fleet manager), via a server, to redirect the refuse vehicle (e.g., either manually or autonomously) based on reported contamination levels.

It should be understood that while certain embodiments described herein refer to only two types of objects (refuse and contaminants/non-refuse), the contamination level detection system may be configured to identify any number of types of objects, refuse, and/or refuse containers using the techniques described herein. For example, the contamination level detection system may be configured to detect items/object not permitted by the refuse management entity and use GPS location received from the GPS system to charge a client associated with the GPS location for disposing of non-permitted objects and/or based on contamination levels that exceed contamination level thresholds. The contamination level detection system may also be configured to detect recyclables and non-recyclables.

FIG. 12 is a flow diagram of a method 1200 of determining contamination levels within the refuse material and presenting (e.g., displaying) the contamination levels to a user. The method 1200 may be performed by the control system 200 of FIG. 2 and will therefore be described with reference to FIG. 2. In other embodiments, the method 1200 may include additional, fewer, and/or different operations.

The method 1200 includes obtaining scan data from a sensor, at 1202. In some embodiments, operation 1202 includes receiving image data from a camera directed toward a hopper or storage volume onboard the refuse vehicle. For example, operation 1202 may include receiving, from the sensor, an image associated with a perception area of the camera as described above with reference to FIGS. 3 and 4.

The method 1200 also includes determining, from the scan data, a level of contamination of the refuse material, at 1204. In some embodiments, operation 1204 includes identifying, by the one or more processors (e.g., the contamination level detection system 240 of FIG. 2, the controller 202 of FIG. 2, the processor 206 of FIG. 2), an object within the perception area of the camera based at least on the scan data (e.g., the image data from a camera). Operation 1204 may further include determining, by the one or more processors, that the object is a contaminant (e.g., a non-refuse object) based at least on the image data.

In some embodiments, operation 1204 includes determining that the identified object is a dangerous contaminant, and generating and transmitting an alert to a user interface device. The alert may require user input, and/or operator intervention to remove the contaminant from the refuse material before further refuse collection operations may be performed. In some embodiments, operation 1204 also includes transmitting the alert to a vehicle control system to signal the control system to prevent further refuse collection and/or vehicle transit operations.

In some embodiments, operation 1204 further includes identifying all contaminants (e.g., non-refuse objects) within the perception area (e.g., at least on layer of refuse material within the hopper or storage volume), and determining an amount of contaminants within the perception area. For example, operation 1204 may include determining a fraction of the perception area (e.g., the hopper or storage volume) occupied by the non-refuse object or contaminant. In some embodiments, operation 1204 also includes classifying the refuse objects (e.g., identifying a type and/or location of all the refuse objects), and determining a total volume of the refuse material contained within the scan data (e.g., the perception area) based on a location of the perimeter and/or position of the refuse and non-refuse objects. In some embodiments, operation 1204 includes applying a multiplier (e.g., a weighting factor) to the fraction or amount based on the type of contaminant detected (e.g., using a greater weighting factor for hazardous contaminants as compared to harmless organic waste in a recycling stream, etc.).

In some embodiments, operation 1204 includes determining a mass fraction of the non-refuse objects and/or contaminants within the refuse material. For example, operation 1204 may include determining an approximate combined weight of the non-refuse objects and/or contaminants identified within the perception area based on density information for different types of non-refuse objects and contaminants stored in memory in combination with the volume or area determination discussed above.

In some embodiments, operation 1204 may also include determining a combined weight of the refuse objects within the hopper volume or the storage volume. In some embodiments, the contamination level detection system may be configured to receive sensor data indicative of the mass of the refuse material from a sensor coupled to the refuse vehicle (e.g., coupled to a lower wall of the hopper volume, the grabber arm, etc.). Operation 1204 may include determining the mass fraction by dividing the determined mass of the non-refuse objects and/or contaminants by the total mass of the refuse material.

The method 1200 further includes transmitting, by the one or more processors (e.g., by the contamination level display system), a signal indicative of the level of contamination of the refuse material, at 1206. In some embodiments, operation 1206 includes transmitting a signal indicative of the mass fraction, area fraction, or volume fraction of contamination to a display or contamination indicator of a user interface onboard the refuse vehicle. For example, operation 1206 may include transmitting the signal to the user interface, which may include any of the user interface elements described with reference to FIGS. 7-11 to cause the user interface to display a percentage of the of the at least one non-refuse object and/or contaminant within the refuse material (either within the hopper volume or in the storage volume). In some embodiments, operation 1206 includes transmitting an alert responsive to the display to notify the operator of hazardous contaminants, or to prompt the operator to take action.

In some embodiments, operation 1206 may also include comparing the contamination level to a contamination level threshold, and transmitting a control signal to the control system of the vehicle when the contamination level satisfies (e.g., is greater than or equal to, etc.) the contamination level threshold. The control signal may be configured to generate operator instructions and/or to re-route the vehicle to a different transfer station or location, as described above.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis supporting a plurality of tractive elements;
a body assembly coupled to the chassis, the body assembly defining a refuse compartment;
a sensor coupled to the body assembly and configured to generate scan data of refuse material associated with the refuse compartment;
a contamination level indicator comprising a scale indicator; and
a controller communicably coupled to the sensor and the contamination level indicator, the controller configured to:
receive the scan data from the sensor;
determine a level of contamination of an object within the refuse material based on the scan data; and
transmit a signal indicative of the level of contamination to the contamination level indicator to cause the scale indicator to present the level of contamination.

2. The refuse vehicle of claim 1, wherein the sensor is a camera facing toward the refuse compartment, and wherein the scan data comprises images obtained by the camera.

3. The refuse vehicle of claim 1, wherein determining the level of contamination comprises:
determining a total amount of the refuse material contained within the scan data;
identifying the object within the refuse material; and
determining a fraction of the total amount of the refuse material that is occupied by the object.

4. The refuse vehicle of claim 3, wherein determining the level of contamination further comprises determining at least one of a mass fraction of the object or a volume fraction of the object within the refuse material, and wherein the controller is further configured to cause the scale indicator to display the mass fraction or the volume fraction.

5. The refuse vehicle of claim 1, wherein the controller is configured to cause the scale indicator to generate an alert when the level of contamination exceeds a contamination level threshold.

6. The refuse vehicle of claim 1, wherein the level of contamination is a percentage of the object within the refuse material.

7. The refuse vehicle of claim 1, wherein the scale indicator includes a plurality of light elements extending along a length thereof, wherein the controller is further configured to transmit the signal to the scale indicator to illuminate at least a subset of the plurality of light elements to indicate the level of contamination within the refuse material.

8. The refuse vehicle of claim 1, further comprising:
a non-working component control interface for controlling a drivetrain element of the refuse vehicle; and
a working component control interface for controlling a working component of the refuse vehicle, wherein the contamination level indicator is coupled to one of the non-working component control interface or the working component control interface.

9. The refuse vehicle of claim 1, wherein the contamination level indicator is positioned in line with a field of view of an operator when driving the refuse vehicle.

10. The refuse vehicle of claim 1, further comprising a lift assembly coupled to the body assembly, wherein the sensor has a perception area including an area through which all refuse material entering the refuse compartment passes after being dumped by the lift assembly but before coming to rest within the refuse compartment.

11. A contamination level detection system for a refuse vehicle, the contamination level detection system comprising:
a sensor configured to generate scan data of refuse material within a refuse compartment of the refuse vehicle;
a contamination level indicator comprising a scale indicator; and
a controller communicably coupled to the sensor and the contamination level indicator, the controller configured to:
receive the scan data from the sensor;
determine a level of contamination of an object within the refuse material based on the scan data; and
cause the contamination level indicator to present an indication of the level of contamination on the scale indicator.

12. The contamination level detection system of claim 11, wherein the sensor is a camera facing toward the refuse compartment, and wherein the scan data comprises images obtained by the camera.

13. The refuse vehicle of claim 11, wherein determining the level of contamination further comprises determining at least one of a mass fraction of the object or a volume fraction of the object within the refuse material, and wherein the controller is further configured to cause the scale indicator to display the mass fraction or the volume fraction normalized by a threshold contamination fraction.

14. The contamination level detection system of claim 11, wherein the scale indicator includes a plurality of light elements extending along a length thereof, wherein the controller is further configured to cause the scale indicator to illuminate at least a subset of the plurality of light elements to indicate the level of contamination within the refuse material.

15. The contamination level detection system of claim 11, wherein the contamination level indicator includes a mount that is configured to couple the contamination level indicator to one of a non-working component control interface for controlling a drivetrain element of the refuse vehicle or a working component control interface for controlling a working component of the refuse vehicle.

16. The contamination level detection system of claim 11, wherein the controller is configured to cause the scale indicator to generate an alert when the level of contamination exceeds a contamination level threshold.

17. The contamination level detection system of claim 11, wherein the scale indicator is part of at least one of a joystick, a steering wheel, or a mirror.

18. A method of determining and displaying a level of contamination of refuse material in a refuse vehicle on a contamination level indicator disposed within the refuse vehicle, the contamination level indicator comprising a scale indicator, the method comprising:
receiving scan data from a sensor of refuse material associated with a refuse compartment;
determining a level of contamination of an object within the refuse material based on the scan data; and
transmitting a signal indicative of the level of contamination to a contamination level indicator to cause the scale indicator to present the level of contamination.

19. The method of claim 18, wherein transmitting the signal to cause the scale indicator to present the level of contamination comprises causing the scale indicator to illuminate at least a subset of a plurality of light elements extending along a length thereof to indicate the level of contamination within the refuse material.

20. The method of claim 18, wherein transmitting the signal to cause the scale indicator to present the level of contamination comprises transmitting the signal to a scale indicator positioned in line with a field of view of an operator of a vehicle when driving the vehicle.
